(19) United States
(12) Patent Application Publication
(10) Pub. No.: US 2026/0257860 A1
(43) Pub. Date: Sep. 3, 2026

(54) ACTUATOR FOR MOVING A STORAGE CONTAINER

(71) Applicant: Autostore Technology AS, Nedre Vats (NO)

(72) Inventors: Trond Austrheim, Nedre Vats (NO); Ivar Fjeldheim, Nedre Vats (NO); Simen Aarseth, Nedre Vats (NO); Magne Hatteland, Nedre Vats (NO)

(73) Assignee: Autostore Technology AS, Nedre Vats (NO)

(21) Appl. No.: 19/159,988

(22) PCT Filed: Feb. 27, 2024
(86) PCT No.: PCT/EP2024/054996

§ 371 Date: Aug. 26, 2025

(30) Foreign Application Priority Data
Feb. 27, 2023 (NO) 20230190

(51) Int. Cl. B65G 1/06; B65G 1/04

(52) U.S. Cl. CPC B65G 1/06; B65G 1/0464; B65G 2201/0235

(57) ABSTRACT

The present disclosure relates to an actuator for moving a storage container, wherein the actuator comprises: a base comprising a support arranged to support a storage container in a first position on a support plane or in a second position on the support plane; a slider movable, relative to the base, in a first direction parallel to the support plane and a second direction opposite the first direction; a driver arranged to move the slider in the first and second directions; and an engagement member coupled to the slider. The engagement member is configured to move relative to the slider between an raised position and a lowered position. In the raised position, a portion of the engagement member protrudes above the support plane. In the lowered position, the portion of the engagement member is retracted beneath the support plane.

### FIELD

The present disclosure relates to an actuator for moving a storage container. The present disclosure also relates to a drawer for a storage container. The present disclosure also relates to an access station for presentation of a storage container for picking. The present disclosure also relates to an automated storage and retrieval system comprising a framework structure. The present disclosure also relates to a method for presentation of a storage container from an automated storage and retrieval system for picking.

### BACKGROUND

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301b,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns are storage columns 105, i.e. columns 105 where storage containers 106 are stored in stacks 107. In addition to storage columns 105, there are special-purpose columns within the framework structure. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

WO2022/136299 describes an access station for presentation of a storage container from an automated storage and retrieval system for picking. The access station comprises an access module comprising a frame defining a drawer compartment provided within the frame and a drawer comprising a drawer base and a drawer front. The drawer is movably connected to the frame. A drawer actuator is used for moving the drawer relative to the frame between a presentation position in which the drawer is protruding from the drawer compartment and a retracted position in which the drawer is retracted within the drawer compartment. The drawer base comprises a support on which the storage container can be supported in a front position or in a rear position. The access station comprises a container actuator for moving the storage container from the front position to the rear position. The storage container is presented for picking to a picker when the storage container is in the front position and the drawer is in the presentation position.

The handling of the storage containers is done by moving the drawer in and out from the drawer compartment and by moving storage containers within the drawer. In addition, storage containers are lifted down into and up from the access station by means of container handling vehicles. The movement of the storage containers to, from and within the access station should be as efficient as possible.

At least preferred embodiments improve the efficiency of the access station and the automated storage and retrieval system.

### SUMMARY

This summary is provided to introduce in simplified form a selection of concepts that are further described herein. The summary is not intended to identify key or essential features of the invention.

The present disclosure relates to an actuator (e.g. a container actuator) for moving a storage container, wherein the actuator comprises a base comprising a support arranged to support a storage container in a first position (e.g. a front or forward position) on a (virtual) support plane or in a second position (e.g. a rear or backward position) on the support plane; a slider movable, relative to the base, in a first direction parallel to the support plane and a second direction opposite the first direction; a driver (e.g. a motor) arranged to move the slider in the first and second directions; and an engagement member (e.g. a lug) coupled to the slider. The engagement member is configured to move relative to the slider between an raised position and a lowered position. In the raised position, a portion of the engagement member protrudes above the support plane (or e.g. above an upper surface of the slider), and in the lowered position, the portion of the engagement member is retracted beneath the support plane (or e.g. beneath an upper surface of the slider).

Upon application of an external force on the portion of the engagement member in the first direction, the engagement member may be arranged to remain in the raised position. Upon application of an external force on the portion of the engagement member in the second direction, the engagement member may be arranged to move from the raised position to the lowered position.

The engagement member can be configured to be the lowered position in order to allow the engagement member to slide underneath a storage container positioned on the support during movement of the slider in the first direction. The engagement member can be configured to be in the raised position in order to push the storage container during movement of the slider in a second direction opposite to the first direction such that the storage container is moved from the first position to the second position.

The engagement member may be pivotably connected to the slider so as to move between the raised position and the lowered position.

The engagement member comprises an engagement surface on the portion of the engagement member that protrudes above the support plane. The engagement member may be arranged to be forced from the raised position to the lowered position when the engagement surface engages a storage container during movement of the slider in the first direction. The engagement surface may be inclined with respect to the support plane when the engagement member is in the raised position.

The engagement member may be biased to the raised position. An example of this is where the actuator comprises a spring arranged to bias the engagement member to the raised position. Another example of this is where the engagement member is weighted to cause the engagement member to pivot from the lowered position to the raised position.

The actuator may further comprise a stop arranged to engage the engagement member to prevent movement of the engagement member when the engagement member is in the raised position.

The actuator may be configured to receive a storage container in the first position during movement of the slider in the first direction.

The present disclosure also provides a drawer for a storage container, the drawer including an actuator and a drawer front, wherein the actuator is any of the actuators (or container actuators) described in the present disclosure.

The present disclosure also provides an access station for presentation of a storage container from an automated storage and retrieval system for picking, wherein the access station comprises an access module comprising a frame defining a drawer compartment provided within the frame and a drawer as described herein. The actuator is arranged to move a storage container from the first position (P1) to the second position, wherein the first position is closer to the drawer front than the second position. The storage container is presented for picking when the storage container is in the first position. The engagement member is configured to be in the lowered position in order to let the engagement member slide underneath the storage container during movement of the slider in the first direction. The engagement member is configured to be in the raised position in order to push the storage container during movement of the slider in the second direction such that the storage container is moved from the first position to the second position.

The present disclosure also relates to an access station for presentation of a storage container from an automated storage and retrieval system for picking, wherein the access station comprises:
a access module comprising a frame defining a drawer compartment provided within the frame;
a drawer comprising a drawer base and a drawer front; wherein the drawer is movably connected to the frame;
wherein the drawer base comprises a support on which the storage container can be supported in a front position or in a rear position;
wherein the access station comprises a container actuator for moving the storage container from the front position to the rear position. The container actuator can be any of the actuators or container actuators described in the present disclosure. The storage container is presented for picking when the storage container is in the front position The container actuator comprises a slider and a motor for moving the slider relative to the drawer base, wherein the container actuator comprises a lug, wherein the lug is configured to be in a lowered position relative to the slider in order to let the lug slide underneath the storage container during movement of the slider in a first direction and wherein the lug is configured to be in a raised position relative to the slider in order to push the storage container during movement of the slider in a second direction opposite of the first direction for moving the storage container from the front position to the rear position.

The picker may be a person. The picker may be a robot. The picker may retrieve an item from the storage container presented by the access station. The picker may insert an item into the storage container presented by the access station. The storage container in the front position is presented for picking when the storage container is in the front position. Hence, the front position may be referred to as the position at which the storage container is closest to the picker, and the rear position is the position at which the storage container is furthest from the picker.

The slider may be horizontally aligned with the support, i.e. the slider and support may lie in the same horizontal plane. The support may comprise two support sections protruding up from the drawer base. The two support sections may be spaced apart. The two support sections may be provided along the sides of the drawer base running perpendicularly to the drawer front. The slider may be provided on top of the drawer base between the two support sections. The motor may move the slider relative to the support.

The storage container may be stationary when supported by the support when the lug slides underneath the storage container during movement of the slider in the first direction. Movement of the storage container in the first direction may be prevented by the drawer front.

The access station may comprise a drawer actuator for moving the drawer relative to the frame between a presentation position in which the drawer is protruding from the drawer compartment and a retracted position in which the drawer is retracted within the drawer compartment.

The lug may be pivotably connected to the slider about an axle.

The axle may be perpendicular to the first direction and the second direction.

The lug may comprise an inclined surface, wherein the lug may be configured to be forced downwardly from the raised position to the lowered position when the inclined surface engages the storage container during movement of the slider in the first direction.

The lug may have a higher weight on one side of the axle than on the other side of the axle, thereby causing the lug to pivot from the lowered state to the raised state when unaffected by external forces.

The container actuator may comprise a spring for biasing the lug to its raised position.

The spring may be compressed when the lug is in the lowered position.

The container actuator may comprise a stop which engages the lug to prevent movement of the lug beyond the raised position.

The access station may be configured to:
receive a further storage container in the front position during movement of the slider in the first direction.

The slider may be defined with a first end position, in which the slider is ready to start movement of the storage container from the front position to the rear position, and a second end position in which the slider has moved the storage container to the rear position. The first end position is adjacent to the drawer front, while the second end position is approximately about mid-way along the drawer base.

According to the above, it is not necessary to hold the further storage container at a distance above the support for the purpose of allowing the slider to move to its end position. Instead, the storage container can be lowered onto the support while the slider is moving to its end position underneath the further storage container. Hence, the container handling vehicle saves time which can be spent on other operations in the automated storage and retrieval system. Hence, the system becomes more efficient. In addition, the drawer may start to open earlier, as the slider may be moving to its end position underneath the further storage container while opening of the drawer. Again, also the access station becomes more efficient.

The access station may comprise a control system for controlling the drawer actuator and the container actuator. The control system of the access station may be provided in communication with a control system of an automated storage and retrieval system.

The access station may comprise a storage container held within the drawer.

The access module may comprise a horizontal lower guiding plate for supporting the drawer front. The drawer actuator comprises a front wheel and a motor for rotating the front wheel. The front wheel is connected to the drawer front. The wheel is configured to run on the horizontal lower guiding plate to move the drawer between the presentation position and the retracted position.

The motor may be secured to the drawer base or to the drawer front.

The front wheel may be connected on a rear side of the drawer front below the drawer base.

The drawer front may comprise a first drawer connection interface for connecting the drawer base to the drawer front at a first height above the horizontal lower guiding plate and wherein the drawer front may comprise a second drawer connection interface for connecting the drawer base to the drawer front at a second height above the horizontal lower guiding plate.

The first drawer connection interface and the second drawer connection interface may comprise holes provided in the drawer front and in the drawer base. The drawer front and the drawer base may be connected to each other by a screw and nut type of connector, or another type of connector.

A rear wheel may be connected to the drawer base and may be configured to support the drawer base, and wherein the access module may comprise a wheel guide for guiding the rear wheel.

The rear wheel may be connected to the underside of the drawer base.

The drawer base may comprise two rear wheels and the access module may comprise two wheel guides, wherein each wheel guide is configured to guide one of the rear wheels.

The access module may comprise a first guide connection interface for connecting the wheel guide to the frame at a first guide height above the horizontal lower guiding plate and wherein the access module may comprise a second guide connection interface for connecting the wheel guide to the frame at a second guide height different from the first guide height above the horizontal lower guiding plate.

A drawer having a first depth is be created when the drawer base is connected to the first drawer connection interface of the drawer front and when the wheel guide is connected to the first guide connection interface of the frame, whereby the access station is adapted to receive a storage container having a first container height.

The drawer base may be oriented in the horizontal plane. The drawer front may be oriented in the vertical plane.

A drawer having a second depth may be created when the drawer base is connected to the second drawer connection interface of the drawer front and when the wheel guide is connected to the second guide connection interface of the frame, whereby the access station is adapted to receive a storage container having a second container height being different from the first container height.

Hence, it is achieved that the drawer may have a depth broadly equivalent to the height of the storage container for different storage containers. Moreover, it is achieved that the top of the container is presented at the same height for different storage containers.

The rear wheels may be non-powered wheels. Alternatively, the rear wheels may be motor-driven wheels.

The present disclosure also relates to an automated storage and retrieval system comprising a framework structure, wherein the framework structure comprises:
upright members;
a storage volume comprising storage columns provided between the members, wherein storage containers are stackable in stacks within the storage columns;
a rail system provided on top of the upright members;
wherein the automated storage and retrieval system comprises container handing vehicles moving on the rail system;
wherein the automated storage and retrieval system comprises an access station according to the preceding aspect of the disclosure or any of the other access stations described in the present disclosure, optionally including any optional features thereof;
wherein the drawer compartment is provided within the framework structure.

The drawer may be configured to at least partially protrude from the framework structure in the presentation position.

The container handling vehicles may be configured to:
retrieve the storage container from the drawer via one storage column;
deliver a further storage container to the drawer via the one storage column.

The present disclosure also relates to a method for presentation of a storage container from an automated storage and retrieval system for picking, wherein the method comprises the following steps:
a) receiving a first storage container in a front position of a drawer when the drawer is in a retracted position within a drawer compartment of an access module;
b) moving a slider relative to the drawer in a first direction, wherein an engagement member (or lug) of (or coupled to) the slider moves relative to the slider into a lowered position by contact with the first storage container, to slide underneath the first storage container;
c) moving the drawer relative to the drawer compartment to a presentation position in which the first storage container is presented for picking;
d) moving the drawer to a retracted position within the drawer compartment;
e) moving the slider relative to the drawer in a second direction, wherein the lug is in a raised position relative to the slider to engage the first storage container and push the first storage container from the front position to the rear position of the drawer.

The method further may comprise the steps of:
f) receiving a second storage container in the front position of the drawer when the drawer is in the retracted position;
g) moving the slider relative to the drawer in the first direction, wherein the lug of the slider moves into the lowered position relative to the slider by contact with the second storage container, to slide underneath the second storage container;
h) moving the drawer relative to the drawer compartment to a presentation position in which the second storage container is presented for picking;
i) retrieving the first storage container from the rear position of the drawer when the drawer is in the presentation position;
j) moving the drawer to the retracted position within the drawer compartment;
k) moving the slider relative to the drawer in the second direction, wherein the lug is in the raised position relative to the slider to engage the second storage container and push the second storage container from the front position to the rear position of the drawer.

The method step a) and/or the method step f) may comprise the step of receiving the first storage container from within a framework structure of the automated storage and retrieval system.

The method step i) may comprise the step of retrieving the first storage container back into the framework structure of the automated storage and retrieval system.

The present disclosure also relates to an actuator for moving a storage container, wherein the actuator comprises:
a base comprising a support on which a storage container can be supported in a first position or in a second position;
a slider provided above the base;
a motor for moving the slider relative to the base;
wherein the actuator comprises a lug, wherein the lug is configured to be in a lowered position relative to the slider in order to let the lug slide underneath the storage container during movement of the slider in a first direction and wherein the lug is configured to be in a raised position relative to the slider in order to push the storage container during movement of the slider in a second direction opposite to the first direction for moving the storage container from the first position to the second position.

### BRIEF DESCRIPTION OF THE DRAWINGS

Following drawings are appended to facilitate the understanding of the invention. The drawings show embodiments, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective view of a prior art access station.

FIG. 6a illustrates a perspective view of an access station according to an embodiment installed in an automated storage and retrieval system, wherein the drawer is in the presentation position.

FIG. 6b illustrates a perspective view of the access station of FIG. 6a, wherein the drawer is in the retracted position.

FIG. 6c illustrates a perspective view of the access station of FIG. 6b, wherein the drawer is in the presentation position.

FIG. 7 is a perspective rear view of the drawer turned upside down.

FIG. 8 is a perspective rear view of the drawer.

FIG. 9a schematically illustrates the slider and the lug of the container actuator with the lug in its lowered position.

FIG. 9b schematically illustrates the slider and the lug of the container actuator with the lug in its raised position.

FIG. 10 schematically illustrates a side view of the drawer in a first state.

FIG. 11 schematically illustrates a side view of the drawer in a second state.

FIGS. 12a-f and FIGS. 13a-h illustrate schematically the operation of the access station.

FIG. 14a and FIG. 14b illustrate an alternative embodiment of the slider and the lug of the container actuator with the lug in its lowered and raised positions respectively.

### DETAILED DESCRIPTION

In overview, embodiments provide an actuator arranged to move a storage container from a first position to a second position. The actuator includes a base which provides support for a storage container on a support plane and a slider arranged to move back and forth in a dimension parallel to the support plane. The actuator also includes an engagement member which is arranged to move relative to the slider between a raised position and a lowered position. When moved by the slider in a first horizontal direction against a first side of a storage container, the engagement member is moved from the raised position to the lowered position through contact with the storage container. Continued movement of the engagement member in the first horizontal direction causes the engagement member to slide underneath the storage container while urging against the underside of the storage container. When engagement member moves past the end of the storage container such that it no longer urges against the underneath of the storage container, the engagement member returns from the lowered position to the raised position. When moved in a second horizontal direction opposite the first horizontal direction against a second side of the storage container opposite the first side, the engagement member is arranged to remain in the raised position and move the storage container by pushing it in the second direction. The engagement member can be biased towards the raised position by a biasing force. The biasing force may be less than the weight of an empty storage container which the drawer is configured to handle such that it does not lift the container when passing underneath. At least a portion of the engagement member moves vertically between the raised position and the lowered position. The engagement member may rotate or pivot between the raised position and lowered position. Movement from the lowered position to the raised position is controlled by the biasing force, and movement from the raised position to the lowered position is controlled by the horizontal movement of the engagement member against a side surface of a storage container. This kind of passive movement between the raised and lowered positions is a simplified mechanism allowing moving a container horizontally when only a single direction of movement is required. This can reduce the complexity of control of the container actuator since the engagement member is effectively controlled by movement of the slider. Although the storage container and biasing member also contribute to the control of the position of the engagement member, these are also passive in that no separate driving mechanism is needed to raise or lower the engagement member. This overview is provided to introduce in simplified form a selection of concepts that are further described herein. The overview is not intended to identify key or essential features of the invention.

In the following, embodiments will be discussed in more detail with reference to the appended drawings. It should be understood, however, that the drawings are not intended to limit the present disclosure to the subject-matter depicted in the drawings.

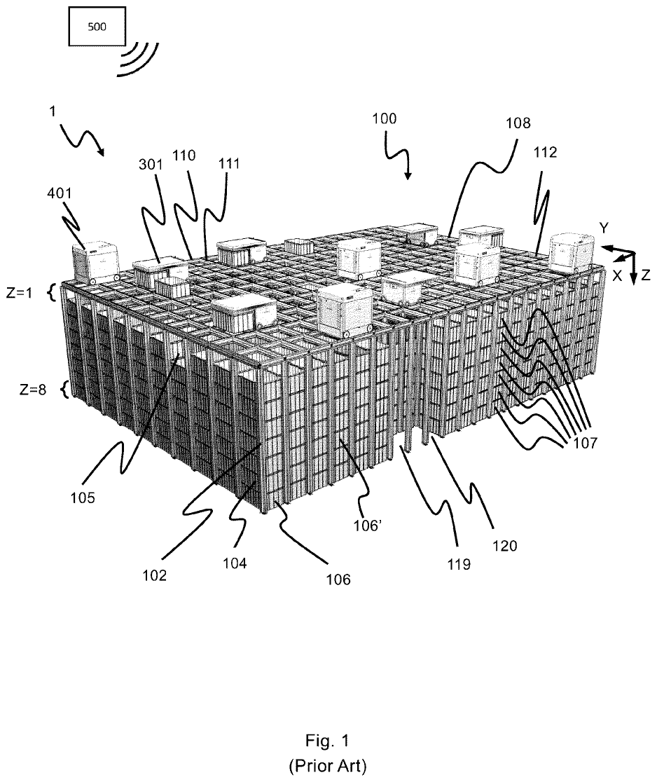

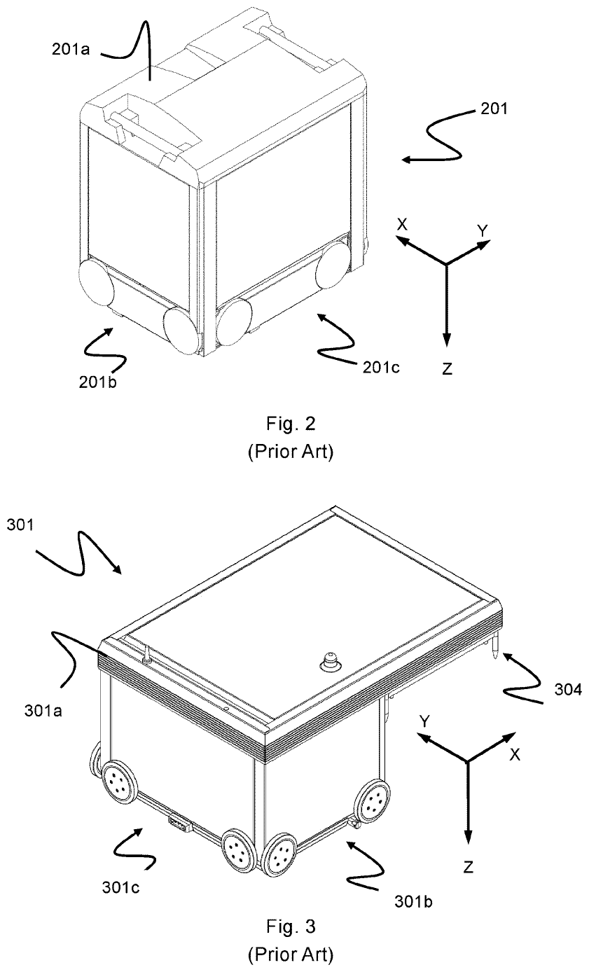

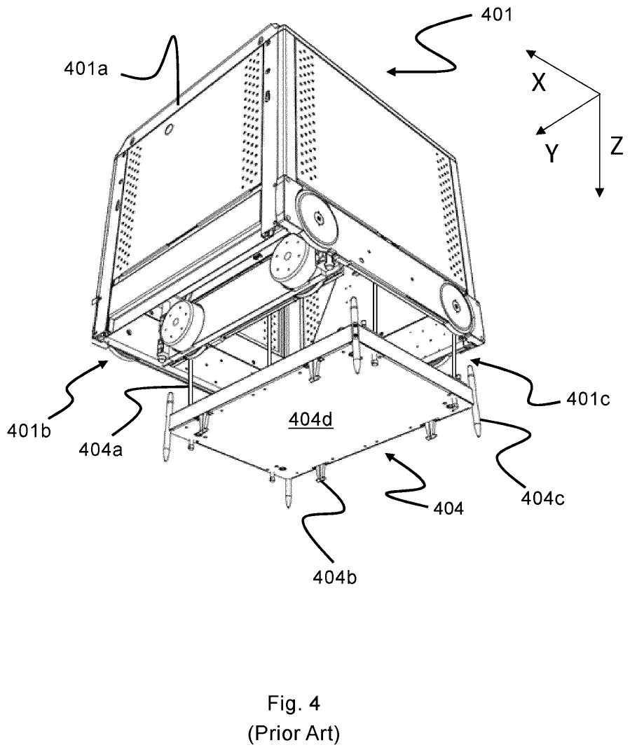

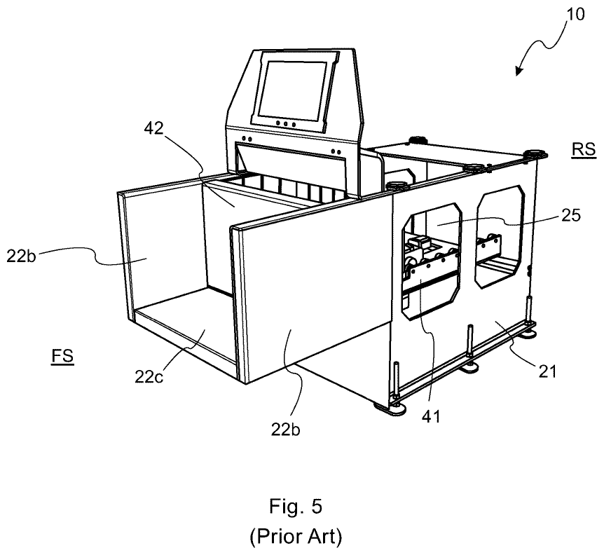

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

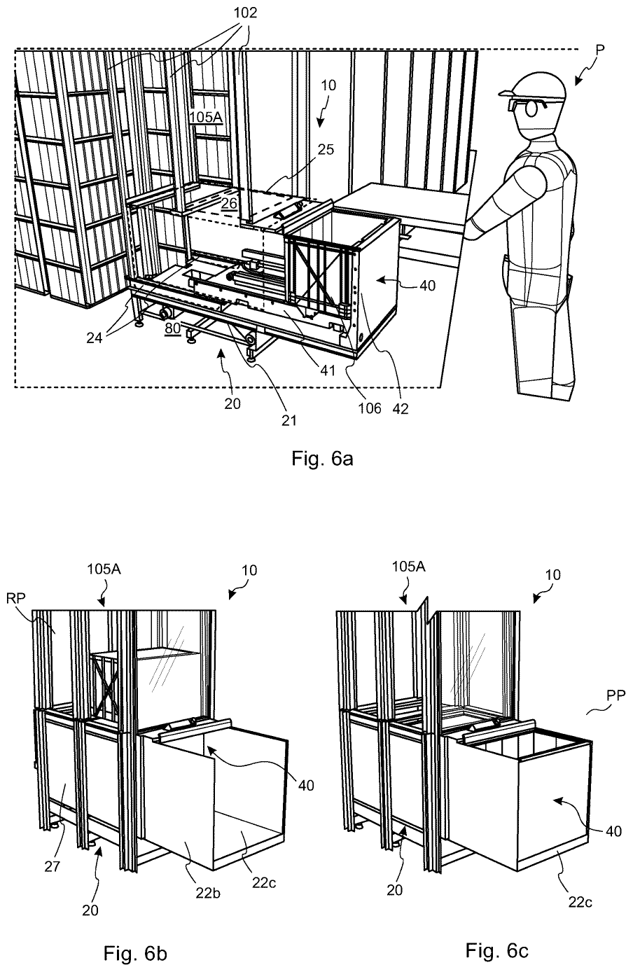

FIGS. 6a. 6b and 6c show a first embodiment of the access station 10.

In FIG. 6a, the access station 10 is shown to comprise an access module 20 and a drawer 40.

The access module 20 comprises a frame 21 defining a drawer compartment 25 provided within the frame 21. The drawer compartment 25 is indicated with a dashed outline in FIG. 6a. It is shown that the frame 21 is supporting six upright members 102 (one being partially hidden behind a panel above the access station) of a framework structure 100 of an automated storage and retrieval system 1. One of the storage columns of the framework structure 100, indicated in the drawings as storage column 105A, is used to move the storage container 106 vertically into the access station 10 and vertically out from the access station 10. It is further shown in FIG. 6a that the access station 10 comprises a top opening indicated as a dashed rectangle 26 through which storage containers are inserted into and retrieved from the access station 10.

The drawer 40 comprises a drawer base 41 and a drawer front 42. The drawer 40 is movably connected to the frame 21. Two storage containers 106 can be stored within the drawer 40. The two positions of the storage containers 106 are referred to as a front position P1 and a rear position P2 (see FIG. 13a, for example), where the front position P1 is the position closest to the drawer front 42. The drawer 40 can be moved between a presentation position in which the drawer 40 protrudes from the drawer compartment 25 (as shown in FIG. 6a and FIG. 6c) and a retracted position in which the drawer 40 is retracted within the drawer compartment 25 (as shown in FIG. 6b). In the presentation position the storage container 106 in the front position P1 is presented for picking to a picker P, which may be a person or a robot.

It is further shown in FIG. 6b that the frame 21 comprises vertical side guiding plates 22b for guiding the drawer front 42 as it extends out to the presentation position and as it retracts to the retracted position. The frame 21 also comprises a horizontal lower guiding plate 22c for supporting and guiding the lower end of the drawer front 42. These guiding plates protrude from a front side FS of the access station 10. A rear side RS of the access station is defined as the opposite side to the front side FS. The rear side RS of the access station 10 will typically be located inside the framework structure 100, while the guiding plates on the front side FS will protrude from the framework structure 100.

As will be described further in detail below, the access station 10 comprises a drawer actuator 60 for moving the drawer 40 between the retracted position and the presentation position and a container actuator 70 for moving the storage container 106 from the front position P1 to the rear position P2.

### The Drawer Actuator 60

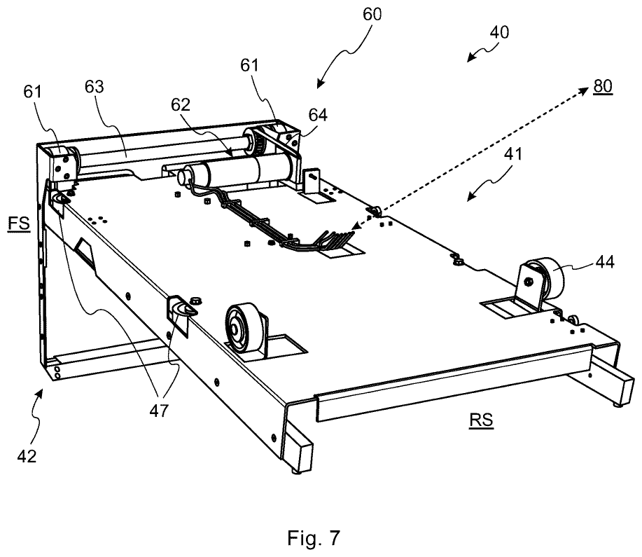

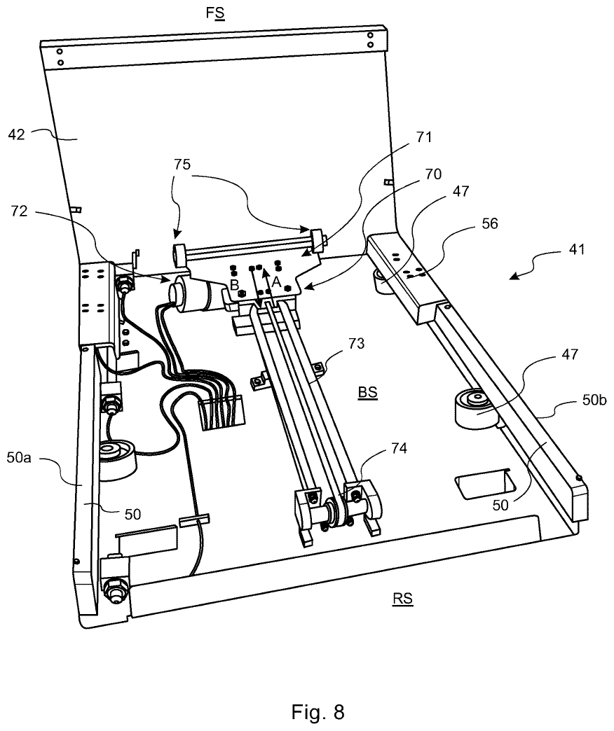

The drawer actuator 60 will now be described with reference to FIGS. 7 and 8. In FIG. 7, it is shown that the drawer actuator 60 comprises two front wheels 61 connected to each other via a shaft 63 and a motor 62 for rotating the shaft 63 via a drive belt 64. The front wheels 61 and shaft 63 are connected to the underside of the drawer front 42, while the motor 62 is connected to the underside of the drawer base 41.

It is further shown in FIG. 7 that the front wheels 61 are located on the rear side RS of the drawer front 42 below the drawer base 41 (here, “below” refers to the relative position in the installed position). In this way, the front wheels 61 are hidden from the picker P behind the drawer front 42. In FIG. 6c, only the drawer front is seen from the position of the picker. As the distance between the drawer front and the lower guiding plate in this way can be made very small, the risk of pinch injuries are reduced.

The drawer 40 further comprises two rear wheels 44 connected to a rear side of the underside of the drawer base 41 and two side wheels 47 connected on each side of the drawer base 41, running perpendicular to the drawer front. Hence, there are two rear wheels 44 and four side wheels 47. In the present embodiment, the rear wheels 44 and the side wheels 47 are not powered wheels.

The front wheels 61 are configured to run on the horizontal lower guiding plate 22c to move the drawer 40 between the presentation position and the retracted position.

The rear wheels 44 are configured to run on or within wheel guides 24 (see FIG. 6a) secured to the access module 20.

The side wheels 47 are configured to run along the vertical side guiding plates 22b and/or along vertical side plates 27 (see FIG. 6b) of the access module 20. Typically, each vertical side guiding plate 22b and vertical side plate 27 is formed as one single plate element. The side wheels 47 reduce friction between the drawer and the access module 20.

The above location of the front wheels 61 enables the drawer to be adjusted in order to accommodate different heights of storage containers, which will be described in detail below.

### Height Adjustment of the Drawer

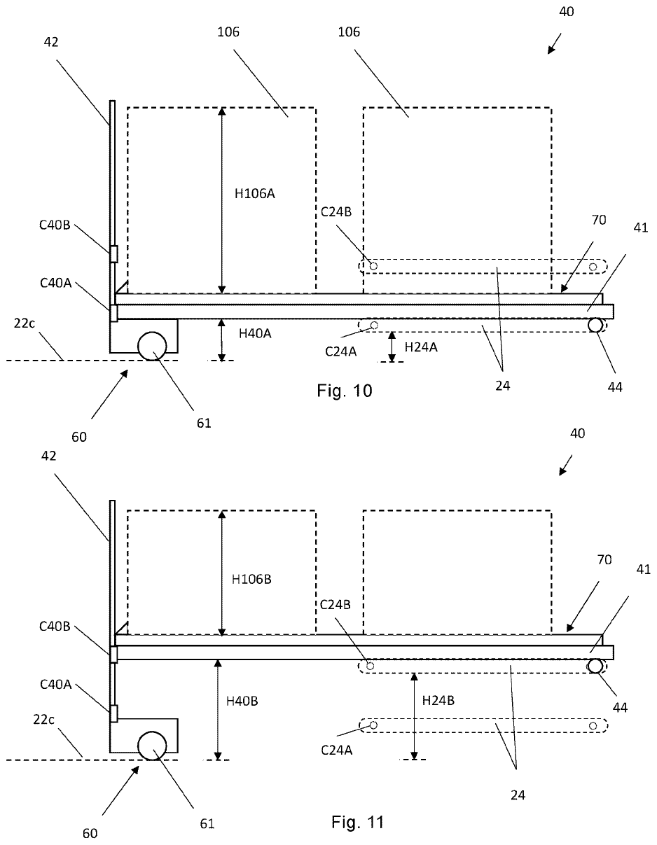

The above storage and retrieval system 1 uses standard-sized storage containers. As an example, the system 1 may be designed for storage containers having a predetermined width and length, determined by the distance between the upright members 102 of the framework structure 100 in the X and Y directions. The height of the storage containers may vary. In some systems, only first storage containers 106A having a first height H106A are used, while in other systems, only second storage containers 106B having a second height H106B are used, wherein the first height H106A is larger than the second height H106B. The different heights are illustrated in FIGS. 10 and 11.

It should be noted that one system 1 may also be configured to use both of the above storage containers. Still, the access station 10 will typically only be designed for one type of storage container.

FIGS. 10 and 11 show that the drawer front 42 comprises a first drawer connection interface C40A for connecting the drawer base 41 to the drawer front 42 at a first height H40A above the horizontal lower guiding plate 22c. The drawer front 42 comprises a corresponding second drawer connection interface C40B for connecting the drawer base 41 to the drawer front 42 at a second height H40B above horizontal lower guiding plate 22c. When comparing FIG. 10 with FIG. 11, it is apparent that the second height H40B is greater than the first height H40A.

The first drawer connection interface C40A and the second drawer connection interface C40B may comprise holes, threaded holes etc. provided in the drawer front 42 and/or in the drawer base 41. The drawer front 42 and the drawer base 41 may be connected to each other by a screw, or by a screw and nut type of connector. However, other types of connectors and connection interfaces may be used.

The access module 20 comprises a first guide connection interface C24A for connecting the wheel guide 24 to the frame 21 at a first guide height H24A above the horizontal lower guiding plate 22c. The access module 20 comprises a corresponding second guide connection interface C24B for connecting the wheel guide 24 to the frame 21 at a second guide height H24B. When comparing FIG. 10 with FIG. 11, it is apparent that the second height H24B is greater than the first height H24A.

The first guide connection interface C24A and the second guide connection interface C24B may comprise holes, threaded holes etc. provided in the frame 21 and/or in the wheel guide 24, for using a screw type of connector, or a screw and nut type of connector etc. to secure the wheel guide 24 to the frame 21. However, other types of connectors and connection interfaces may be used.

As shown in FIG. 10, the drawer 40 has a first depth when the drawer base 41 is connected to the first drawer connection interface C40A of the drawer front 42 and when the wheel guide 24 is connected to the first guide connection interface C24A of the frame 21. Here, the access station 10 is adapted to receive a storage container 106 having a first container height H106A.

As shown in FIG. 11, the drawer 40 has a second depth when the drawer base 41 is connected to the second drawer connection interface C40B of the drawer front 42 and when the wheel guide 24 is connected to the second guide connection interface C24B of the frame 21, whereby the access station 10 is adapted to receive a storage container 106 having a second container height H106B being different from the first container height H106A.

There are several advantages with the above. First, it is relatively easy and efficient to adapt the access station 10 according to the height of the storage container being used by the access station. The only work needed is to fasten the drawer base 41 to the desired one of the first or second drawer connection interface C40A, C40B and to fasten the wheel guide 24 to the desired one of the first or second guide connection interface C24A, C24B. In addition, it may be necessary to choose a drive belt 64 of sufficient length depending on whether the drawer 40 has the first depth or the second depth, due to the difference in distance between the shaft 63 and the motor 62. Alternatively, it may be necessary to reposition the motor 62 to allow the same drive belt 64 to be used.

A second advantage is that the top of the container is presented at the same height independent of the height of the storage containers. This is an advantage for Health, Safety, and Environment (HSE) reasons, and also for efficiency in the picking process.

A third advantage is that storage containers with different height can be guided by the upright members of the framework structure 100 during their vertical movement into and out from the access station 10 via the top opening 26. Also the gripper device of a container handling vehicle is guided by these upright members 102 when lowered towards a storage container in the drawer or when elevated from a storage container in the drawer.

### The Container Actuator 70

The container actuator 70 will now be described in detail, initially with reference to FIG. 8.

Here it is shown that the drawer base 41 comprises a support 50 having two support sections 50a, 50b protruding up from the drawer base 41 along the sides of the drawer base 41. The top surfaces of the support sections 50a, 50b, may define (or be located in) a virtual support plane on which the support containers are situated when placed in the drawer. At the front end of the drawer base 41 (close to the drawer front), the support 50 comprises a weight sensor 56. The storage container 106 can be supported in the front position P1 or in the rear position P2 (see FIG. 13a) on the support 50. When in the front position P1, the weight of the storage container 106 can be measured by the weight sensor 56. The storage container 106 is configured to slide along the top surface of the support 50 (along the two support sections 50a, 50b) when moved from the front position P1 to the rear position P2.

Between the support sections 50a, 50b, the container actuator 70 is located. The container actuator 70 comprises a slider 71, a motor 72, a linear guide 73 and a drive belt 74. The slider 71 is movable along the linear guide 73, i.e. relative to the drawer base 41, by means of the motor 72 and the drive belt 74.

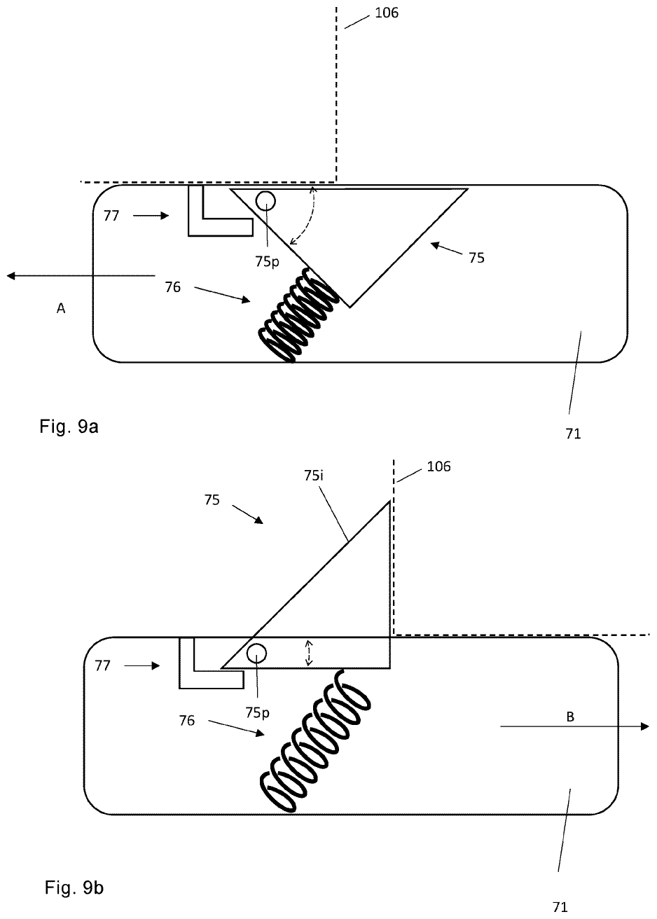

The container actuator 70 further comprises two lugs 75 (which may also be described as engagement members). The lugs 75 will be described in detail with reference to FIGS. 9a and 9b. As shown in FIG. 9a and FIG. 9b, the lug 75 has a triangular cross sectional shape. In FIG. 9a, the lug 75 is shown in its lowered position, i.e. the inclined surface 75i of the lug 75 is aligned with the top surface of the slider 71. In FIG. 9b, the lug 75 is in its raised position, protruding up from the slider 71.

In FIG. 8, two arrows A and B are indicated. Direction A is the direction of the movement of the slider towards the drawer front, and direction B is the direction of the movement of the slider away from the drawer front.

The lug 75 is pivotably connected to the slider 71 about an axle 75p and is hence pivotable between its raised and lowered positions. The axle 75p is perpendicular to the first direction A and the second direction B.

The container actuator 70 further comprises a spring 76 for biasing the lug 75 to its raised position. As shown, the spring 76 is compressed when the lug is in the lowered position.

The container actuator 70 further comprises a stop 77 which engages the lug to prevent the lug 75 pivoting beyond the raised position.

It should be noted that in FIG. 9a and FIG. 9b, a corner of the storage container 106 is indicated with a dashed line.

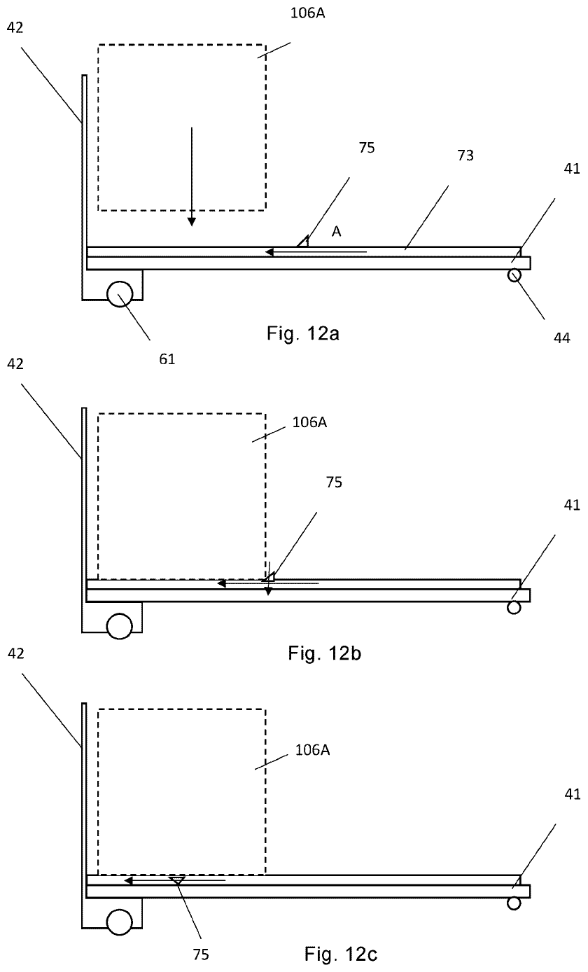

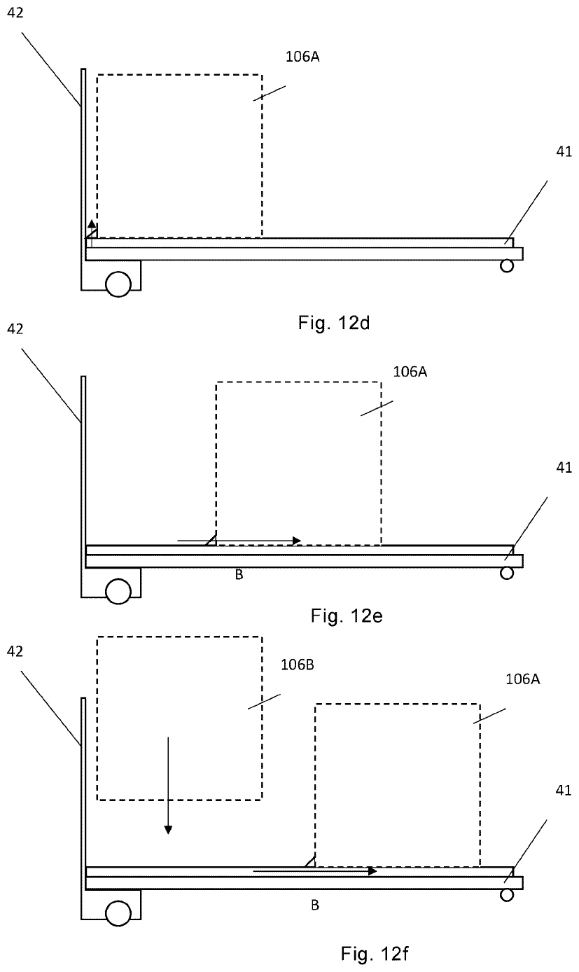

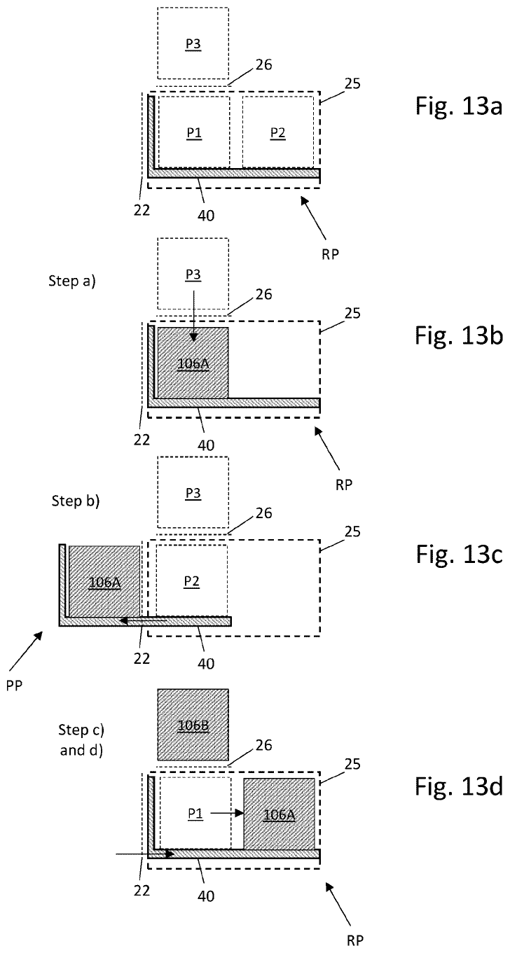

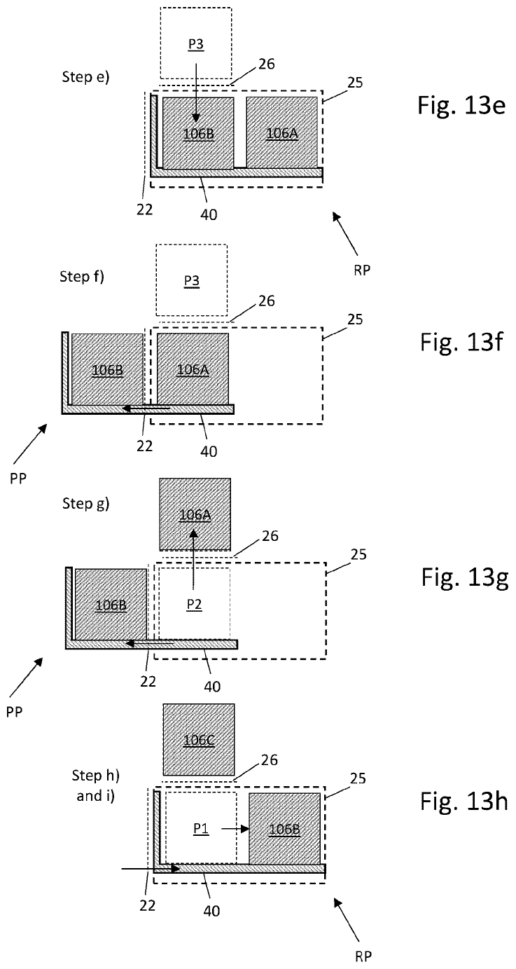

FIGS. 12a-12f and FIGS. 13a-13h illustrate the function of the access station 10. In FIG. 13a, three positions are indicated. The first or front position P1 within the drawer 40 and the second or rear position P2 within the drawer 40 have been described above. In addition, there is a third position P3 above the first position P1. This third position P3 may be referred to as a waiting position.

It should be noted that in FIG. 10 and FIG. 11, reference numbers 106A and 106B are used to denote two storage containers having different height. Below, these reference numbers are used to denote two storage containers with the same height being moved into, out from and inside the access station 10.

In FIG. 12a and FIG. 13b, a first storage container 106A is received in the front position P1 of the drawer 40. In FIG. 13b it is shown that the drawer 40 is in the retracted position within the drawer compartment 25. In FIG. 12a it is shown that the lug 75 and the slider 71 are moving in a first direction A relative to the drawer 40, i.e. towards the drawer front 42, with the lug in the raised position. In FIG. 12b it is shown that the lug 75 moves into a lowered position relative to the slider 71 by contact with the first storage container 106A. Due to friction between the storage container 106A and the support 50, and/or due to the fact that the storage container 106A is prevented to move further towards the drawer front 42, the storage container 106A cannot move to the left in FIG. 12b. The biasing force from the spring 76 is counteracted by the force of pushing against the storage container 106A, and the lug 75 will be forced to its lowered position and slide underneath the first storage container 106A, as shown in FIG. 9a and FIG. 12c. This is helped by the inclined surface 75i of the triangular shaped lug 75, which slides along the edge of the storage container 106 as the lug 75 is pushed into the lowered position.

When the slider 71 and the lug 75 have moved to its front end position, i.e. closest to the drawer front 42, the lug 75 has passed underneath the storage container 106A and will be pushed up from the slider 71 by the spring 76 as shown in FIG. 12d and FIG. 9b. The upward/pivoting movement of the lug 75 will be stopped by stop 77.

In FIG. 13c, it is shown that the drawer 40 is moved relative to the drawer compartment to a presentation position in which the first storage container 106A is presented for picking to the picker P.

In FIG. 13d it is shown that the drawer is moved to the retracted position within the drawer compartment 25 and that the first storage container 106A is moved from the front position P1 to the rear position P2. It is further shown that a second storage container 106B is in the waiting position P3. In FIG. 12e it is shown how the slider 71 is moved in a second direction B (opposite to the fist direction A) with the lug 75 in the raised position relative to the slider 71 to engage the first storage container 106A and push the first storage container 106A from the front position P1 to the rear position P2 of the drawer 40. When moving in the second direction B, the lug 75 will not be pushed down.

In FIG. 12f and FIG. 13e it is shown that the second storage container 106B is received in the front position P1 of the drawer 40 when the drawer is in the retracted position.

The slider 71 is now moved relative to the drawer 40 in the first direction A again, similar to FIG. 12a. The lug 75 of the slider 71 will be moved into the lowered position relative to the slider 71 again by contact with the second storage container 106B, and slide underneath the second storage container 106B. The drawer 40 is again moved relative to the drawer compartment to the presentation position in which the second storage container 106B is presented for picking to the picker P (FIG. 13f). When in the presentation position, the first storage container 106A is retrieved from the rear position P2 of the drawer 40 (FIG. 13g).

Again, the drawer 40 is moved to the retracted position within the drawer compartment 25 (FIG. 13h) and the slider 71 is moved relative to the drawer 40 in the second direction B, wherein the lug 75 is in the raised position relative to the slider 71 to engage the second storage container 106B and push the second storage container 106B from the front position P1 to the rear position P2 of the drawer 40 (similar to FIG. 12e). As shown in FIG. 13h, a third storage container 106C is ready to be moved into the front position again.

According to the above, it is not necessary to hold the further storage container 106B in the waiting position P3 at a distance above the support 50 for the purpose of allowing the slider 71 to move to its end position. Instead, the storage container 106 can be lowered onto the support 50 while the slider 71 is moving to its end position underneath the further storage container 106. Hence, the container handling vehicle 201, 301, 401 saves time which can be spent on other operations in the automated storage and retrieval system 1. Hence, the system 1 becomes more efficient. In addition, the drawer 40 may start to open earlier, as the slider 71 may be moving to its end position underneath the further storage container 106 while opening the drawer 40. Again, the efficiency of the access station 10 is increased.

### Alternative Embodiments

It should be noted that in the embodiments described above, the container carrier comprises two lugs 75 spaced apart from each other, as shown in FIG. 7. It should be noted that there may be one lug, or more than two lugs.

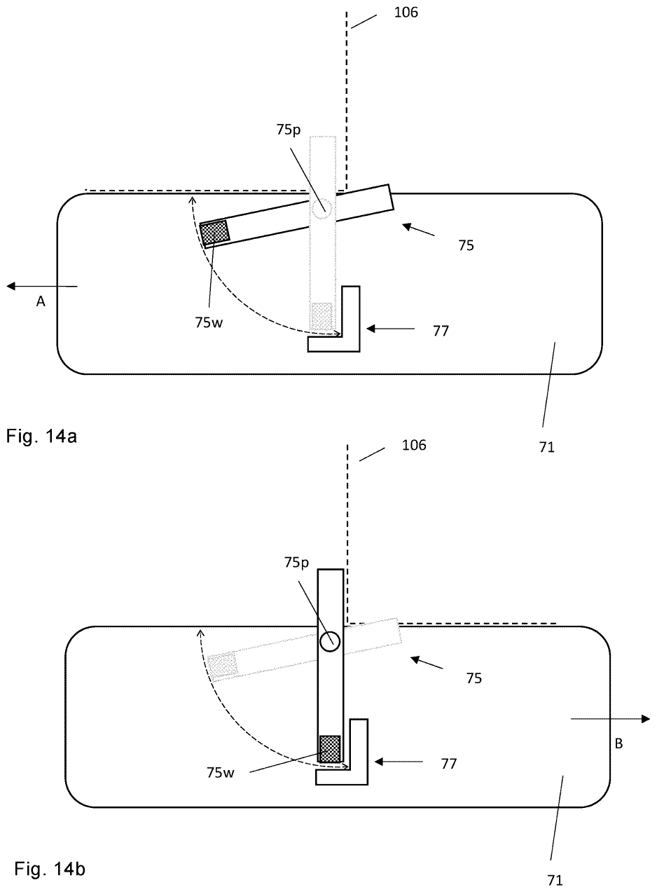

It should further be noted that the lug (or engagement member) 75 does not need to have a triangular shape with an inclined surface, and that the spring 76 is not an essential feature. Referring to FIG. 14a and FIG. 14b, the lug (or engagement member) 75 is shown as an elongated body, with approximately ⅓ of the elongated body located on one side of the axle 75p and approximately ⅔ of the elongated body located on the opposite side of the axle 75p. Assuming that the entire lug 75 is made of the same material, the lug 75 pivots back to the raised position (grey line in FIG. 14a, black line in FIG. 14b) when unaffected by external forces. In FIG. 14a, the lug 75 is pivoted to a horizontal or near horizontal position when meeting the storage container 106 and moving in the first direction A, letting the lug slide underneath the storage container 106. When moving in the other direction B, the stop 77 prevents movement of the lug when the lug comes into contact with a storage container, and the lug is therefore maintained in the raised position, allowing the lug to push the storage container from the front position P1 to the rear position P2.

It should be noted that the ⅓ length and the ⅔ length are exemplary only, and other splits are possible, as long as the required pivoting motion is achieved.

As an alternative to, or in addition to, the provision of the lug with different length relative to the axle 75p, a weight element 75w may be secured to, or integrated in, the lug 75 to obtain that the lug 75 will pivot back to the raised position when unaffected by external forces.

The lug or engagement member 75 may perform the functions described herein without a pivoting motion between the raised and lowered positions. For example, the lug or engagement member 75 described with reference to FIG. 9a or FIG. 9b can be provided without the pivot 75p (and without the stop 77). The lug may be held by its connection to the slider 71 (or otherwise) in the orientation shown in FIG. 9b such that the lug does not pivot or rotate even when an external force is applied thereto. A spring may bias the lug to the raised position shown in FIG. 9b. The lug may be allowed to move between the raised and lowered positions on a vertical guide arranged either on the slider or on the lug. The inclined surface of the 75i of the lug, when interacting with a storage container in the position shown in FIG. 9a, is arranged to cause the lug to move vertically downwards from the raised position due to the horizontal force on the inclined surface 75i applied by the storage container 106 when the lug 75 is moved in the first direction A. That is, the vertical guide and inclined surface 75i may act together to translate a horizontal force applied in the second direction B to the lug 75 by the storage container 106 to a vertical force acting downward on the lug so as to move it from the raised position to the lowered position.

The container actuator 70 may not only be used in a drawer 40. The container actuator 70 may also be used to move containers between two positions in other parts of an automated storage and retrieval system 1. In FIG. 7, the drawer base 41 is a substantially planar surface. Other types of planar surfaces, generally referred to as a base BS (see FIG. 8), may be used. The base BS may comprise a support 50 on which a storage container 106 can be supported in a first position P1 or in a second position P2 and the container actuator 70 may be located on the base adjacent to the support 50 or between support sections 50a, 50b. As an example, the base BS may be a part of an access station without a drawer, the base BS may be part of a conveyor etc.

In the preceding description, various features of the access station have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the appended claims.

Also described herein are the following numbered clauses:

### Clause 1

An access station (10) for presentation of a storage container (106) from an automated storage and retrieval system (1) for picking, wherein the access station (10) comprises:
a access module (20) comprising a frame (21) defining a drawer compartment (25) provided within the frame (21);
a drawer (40) comprising a drawer base (41) and a drawer front (42); wherein the drawer (40) is movably connected to the frame (21);
wherein the drawer base (41) comprises a support (50) on which the storage container (106) can be supported in a front position (P1) or in a rear position (P2);
wherein the access station (10) comprises a container actuator (70) for moving the storage container (106) from the front position (P1) to the rear position (P2);
wherein the storage container (106) is presented for picking when the storage container (106) is in the front position (P1);
wherein the container actuator (70) comprises a slider (71) and a motor (72) for moving the slider (71) relative to the drawer base (41), wherein the container actuator (70) comprises a lug (75), wherein the lug (75) is configured to be in a lowered position relative to the slider (71) in order to let the lug (75) slide underneath the storage container (106) during movement of the slider (71) in a first direction (A) and wherein the lug (75) is configured to be in a raised position relative to the slider (71) in order to push the storage container (106) during movement of the slider (71) in a second direction (B) opposite to the first direction (A) for moving the storage container (106) from the front position (P1) to the rear position (P2).

### Clause 2

The access station (10) according to clause 1, wherein the lug (75) is pivotably connected to the slider (71) about an axle (75p).

### Clause 3

The access station (10) according to clause 1 or 2, wherein the lug (75) comprises an inclined surface (75i), wherein the lug (75) is configured to be forced downwardly from the raised position to the lowered position when the inclined surface (75i) engages the storage container (106) during movement of the slider (71) in the first direction (A).

### Clause 4

The access station (10) according to clause 2 or 3, wherein the container actuator (70) comprises a spring (76) for biasing the lug (75) to its raised position.

### Clause 5

The access station (10) according to clause 2 wherein the lug (75) has a higher weight on one side of the axle (75p) than on the other side of the axle (75p), thereby causing the lug (75) to pivot from the lowered state to the raised state when unaffected by external forces.

### Clause 6

The access station (10) according to any preceding clause, wherein the container actuator (70) comprises a stop (77) which engages the lug to prevent movement of the lug (75) beyond the raised position.

### Clause 7

The access station (10) according to any preceding clause, wherein the access station (10) is configured to:
receive a further storage container (106) in the front position (P1) during movement of the slider (71) in the first direction (A).

### Clause 8

An automated storage and retrieval system (1) comprising a framework structure (100), wherein the framework structure (100) comprises:
upright members (102);
a storage volume comprising storage columns (105) provided between the members (102, 103), wherein storage containers (106) are stackable in stacks (107) within the storage columns (105);
a rail system (108) provided on top of the upright members (102);
wherein the automated storage and retrieval system (1) comprises container handing vehicles (201, 203) moving on the rail system (108);
wherein the automated storage and retrieval system (1) comprises an access station (10) according to any preceding clause;
wherein the drawer compartment (25) is provided within the framework structure (100).

### Clause 9

The automated storage and retrieval system (1) according to clause 8, wherein the container handling vehicles (201, 301) are configured to:
retrieve the storage container (106) from the drawer (40) via one storage column (105A);
deliver a further storage container (106) to the drawer (40) via the one storage column (105A).

### Clause 10

A method for presentation of a storage container (106) from an automated storage and retrieval system (1) for picking, wherein the method comprises the following steps:
a) receiving a first storage container (106A) in a front position (P1) of a drawer (40) when the drawer is in a retracted position (RP) within a drawer compartment (25) of an access module (20);
b) moving a slider (71) relative to the drawer (40) in a first direction (A), wherein a lug (75) of the slider (71) moves into a lowered position relative to the slider (71) by contact with the first storage container (106A), to slide underneath the first storage container (106);
c) moving the drawer (40) relative to the drawer compartment to a presentation position (PP) in which the first storage container (106A) is presented for picking;
d) moving the drawer (40) to a retracted position (RP) within the drawer compartment (25);
e) moving the slider (71) relative to the drawer (40) in a second direction (B), wherein the lug (75) is in a raised position relative to the slider (71) to engage the first storage container (106A) and push the first storage container (106A) from the front position (P1) to the rear position (P2) of the drawer (40).

### Clause 11

The method according to clause 10, wherein the method further comprises the steps of:
f) receiving a second storage container (106B) in the front position (P1) of the drawer (40) when the drawer is in the retracted position (RP);
g) moving the slider (71) relative to the drawer (40) in the first direction (A), wherein the lug (75) of the slider (71) moves into the lowered position relative to the slider (71) by contact with the second storage container (106B), to slide underneath the second storage container (106B);
h) moving the drawer (40) relative to the drawer compartment to a presentation position (PP) in which the second storage container (106B) is presented for picking;
i) retrieving the first storage container (106A) from the rear position (P2) of the drawer (40) when the drawer (40) is in the presentation position (PP);
j) moving the drawer (40) to the retracted position (RP) within the drawer compartment (25);
k) moving the slider (71) relative to the drawer (40) in the second direction (B), wherein the lug (75) is in the raised position relative to the slider (71) to engage the second storage container (106B) and push the second storage container (106B) from the front position (P1) to the rear position (P2) of the drawer (40).

### Clause 12

An actuator (70) for moving a storage container (106), wherein the actuator comprises:
a base (BS) comprising a support (50) on which a storage container (106) can be supported in a first position (P1) or in a second position (P2);
a slider (71) provided above the base (BS);
a motor (72) for moving the slider (71) relative to the base (B);
wherein the actuator (70) comprises a lug (75), wherein the lug (75) is configured to be in a lowered position relative to the slider (71) in order to let the lug (75) slide underneath the storage container (106) during movement of the slider (71) in a first direction (A) and wherein the lug (75) is configured to be in a raised position relative to the slider (71) in order to push the storage container (106) during movement of the slider (71) in a second direction (B) opposite to the first direction (A) for moving the storage container (106) from the first position (P1) to the second position (P2).

### LIST OF REFERENCE NUMBERS

1 automated storage and retrieval system
10 access station
20 access module
21 frame
22b vertical side guiding plates
220 horizontal lower guiding plate
24 wheel guide
25 drawer compartment
26 top opening
27 vertical side plates
40 drawer
41 drawer base
42 drawer front
44 rear wheels
47 side wheels
50 support
50a first support section
50b second support sections
56 weight sensor
60 drawer actuator
61 front wheels
62 motor
63 shaft
64 drive belt
70 container actuator
71 slider
72 motor
73 linear guide
74 drive belt
75 lug
75i inclined surface
75p axle
75w weight element
76 spring
77 stop
80 control system
100 framework structure
102 Upright members of framework structure
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
X First direction
Y Second direction
Z Third direction
BS base
C24A first guide connection interface
C24B second guide connection interface
C40A first drawer connection interface
C40B second drawer connection interface
FS Front side
H106A first container height
H106B second container height
H24A first guide height
H24B second guide height
H40A first drawer base height
H40B second drawer base height
P1 first, front position
P2 second, rear position
P3 third, waiting position
PP presentation position
RP retracted position
RS rear side

1. An actuator for moving a storage container, wherein the actuator comprises:
a base comprising a support arranged to support a storage container in a first position on a support plane or in a second position on the support plane;
a slider movable, relative to the base, in a first direction parallel to the support plane and a second direction opposite the first direction;
a driver arranged to move the slider in the first and second directions; and
an engagement member coupled to the slider;
wherein the engagement member is configured to move relative to the slider between a raised position and a lowered position,
wherein, in the raised position, a portion of the engagement member protrudes above the support plane, and in the lowered position, the portion of the engagement member is retracted beneath the support plane.

2. The actuator according to claim 1, whereupon application of an external force on the portion of the engagement member in the first direction, the engagement member is arranged to remain in the raised position, and
whereupon application of an external force on the portion of the engagement member in the second direction, the engagement member is arranged to move from the raised position to the lowered position.

3. The actuator according to claim 1, wherein the engagement member is configured to be in the lowered position in order to allow the engagement member to slide underneath a storage container positioned on the support during movement of the slider in the first direction, and
wherein the engagement member is configured to be in the raised position in order to push the storage container during movement of the slider in the second direction opposite to the first direction such that the storage container is moved from the first position to the second position.

4. The actuator according to claim 1, wherein the engagement member is pivotably connected to the slider so as to move between the raised position and the lowered position.

5. The actuator according to claim 1, wherein the engagement member comprises an engagement surface on the portion of the engagement member, wherein the engagement member is arranged to be forced from the raised position to the lowered position when the engagement surface engages a storage container during movement of the slider in the first direction, and wherein the engagement surface is inclined with respect to the support plane when the engagement member is in the raised position.

6. The actuator according to claim 1, wherein the engagement member is biased to the raised position, and wherein the actuator further comprises a spring arranged to bias the engagement member to the raised position.

7. The actuator according to claim 1, wherein the engagement member is biased to the raised position, and wherein the engagement member is weighted to cause the engagement member to pivot from the lowered position to the raised position.

8. The actuator according to claim 1, further comprising a stop arranged to engage the engagement member to prevent movement of the engagement member when the engagement member in the raised position.

9. The actuator according to claim 1, further configured to:
receive a storage container in the first position during movement of the slider in the first direction.

10. A drawer for a storage container, the drawer comprising the actuator of claim 1 and a drawer front attached to the base.

11. An access station for presentation of a storage container from an automated storage and retrieval system for picking, wherein the access station comprises:
an access module comprising a frame defining a drawer compartment provided within the frame; and
the drawer of claim 10; wherein the drawer is movably connected to the frame,
wherein the actuator is arranged to move a storage container from the first position to the second position, wherein the first position is closer to the drawer front than the second position;
wherein the storage container is presented for picking when the storage container is in the first position,
wherein the engagement member is configured to be in the lowered position in order to let the engagement member slide underneath the storage container during movement of the slider in the first direction, and
wherein the engagement member is configured to be in the raised position in order to push the storage container during movement of the slider in the second direction such that the storage container is moved from the first position to the second position.

12. An automated storage and retrieval system comprising a framework structure wherein the framework structure comprises:
upright members;
a storage volume comprising storage columns provided between the members wherein storage containers are stackable in stacks within the storage columns;
a rail system provided on top of the upright members
wherein the automated storage and retrieval system comprises container handling vehicles moving on the rail system;
wherein the automated storage and retrieval system comprises the access station according to claim 11;
wherein the drawer compartment is provided within the framework structure.

13. The automated storage and retrieval system according to claim 12, wherein the container handling vehicles are configured to:
retrieve the storage container from the drawer via one storage column;
deliver a further storage container to the drawer via the one storage column.

14. A method for presentation of a storage container from an automated storage and retrieval system for picking, wherein the method comprises:
a) receiving a first storage container in a front position of a drawer when the drawer is in a retracted position within a drawer compartment of an access module;
b) moving a slider relative to the drawer in a first direction, wherein an engagement member coupled to the slider moves relative to the slider into a lowered position by contact with the first storage container, to slide underneath the first storage container;
c) moving the drawer relative to the drawer compartment to a presentation position in which the first storage container is presented for picking;
d) moving the drawer to a retracted position within the drawer compartment;
e) moving the slider relative to the drawer in a second direction, wherein the engagement member is in a raised position relative to the slider to engage the first storage container and push the first storage container from the front position to the rear position of the drawer.

15. The method according to claim 14, wherein the method further comprises:
f) receiving a second storage container in the front position of the drawer when the drawer is in the retracted position;
g) moving the slider relative to the drawer in the first direction, wherein the engagement member moves relative to the slider into the lowered position by contact with the second storage container, to slide underneath the second storage container;
h) moving the drawer relative to the drawer compartment to a presentation position in which the second storage container is presented for picking;
i) retrieving the first storage container from the rear position of the drawer when the drawer is in the presentation position;
j) moving the drawer to the retracted position within the drawer compartment;
k) moving the slider relative to the drawer in the second direction, wherein the engagement member is in the raised position relative to the slider to engage the second storage container and push the second storage container from the front position to the rear position of the drawer.
